(19) United States
(12) Patent Application Publication
(10) Pub. No.: US 2006/0265873 A1
(43) Pub. Date: Nov. 30, 2006

(54) Tube finning machine and method

(76) Inventor: David Bland Pierce, Warwick (GB)

Correspondence Address: INTELLECTUAL PROPERTY / TECHNOLOGY LAW, PO BOX 14329, RESEARCH TRIANGLE PARK, NC, 27709, US

(21) Appl. No.: 10/551,857

(22) PCT Filed: Apr. 1, 2004
(86) PCT No.: PCT/IB04/00995

§ 371 Date: Dec. 1, 2005

(30) Foreign Application Priority Data
Apr. 1, 2003 (GB) 0307465.5

(51) Int. Cl. B23P 15/26

(52) U.S. Cl. 29/890.047; 29/727; 29/726.5; 29/890.046

(57) ABSTRACT

This invention relates to a tube finning machine (10) and to a method of use thereof. Typically, the finned tubes will be for use in heat exchangers. In the present invention, the machine (10) has tensioning means (32, 44) for applying tension to the tubes (16) during the finning process, tension in the tubes reducing the likelihood that the tubes will buckle or deform during the process. Also, the invention discloses the use of a solid material introduced between the fins (22) to support the fins during the finning process, the solid material being removed after completion of the process. The solid material can be a granular material, or it can be a continuous material introduced (and removed) in its liquid state.

### FIELD OF THE INVENTION

This invention relates to a tube finning machine and to a method of use thereof.

Typically, the finned tubes will be for use in heat exchangers, and the following description relates primarily to such use. However, the use of the machine and method for other applications is not thereby excluded.

### BACKGROUND TO THE INVENTION

Often it is necessary to cool a working fluid, and it is known for this purpose to use a heat exchanger. Heat exchangers often comprise one or more metallic tubes suspended between two tube plates. Usually, the working fluid to be cooled, which may for example be water or oil, flows through the tubes, whilst the coolant passes around and between those tubes, the working fluid giving up its latent heat to the tubes and thus to the coolant.

The effective surface area of a tube can be enlarged in order to increase the heat transfer, as by the addition of one or more annular extended surface members or fins in thermal contact with the outer surface of the tube. Such finned tubes are particularly useful if the coolant has a low viscosity, and if the coolant is a gas, such as air.

The performance of a heat exchanger in part depends upon the thickness of the wall of the tubes, the degree of thermal contact between the tubes and the fins, and to the total area of the fins. In general, a thinner tube wall and a better thermal contact between the tubes and the fins will increase the heat transfer from the working fluid to the fins, and a greater surface area of the fins will increase the heat transfer into the coolant.

Each tube of the heat exchanger can have independent fins mounted thereupon, so that each finned tube is substantially thermally independent of the other tubes in the heat exchanger. Alternatively, the separate fins of adjacent tubes can be replaced by “common-fins” i.e. fins which engage (and interconnect) several tubes. Typically, a common-fin takes the form of an extended plate having several apertures, each aperture being adapted to receive a respective tube, the plate-like common-fin being in simultaneous thermal contact with several tubes, and being adapted to transfer the heat from all of the tubes to the coolant across the full area between the tubes. An array of tubes to which are mounted a plurality of multi-apertured common-fins is referred to herein as a “fin block”, though in other documents it is also referred to as a “coil block” or “block fin”.

### DESCRIPTION OF THE PRIOR ART

U.S. Pat. No. 3,733,673 discloses a machine for fitting several fins to one or two tubes at the same time. The fins are arranged in a cartridge, and held along their top and bottom edges. Each fin has a number of apertures therein which are sized and shaped to correspond closely with the outer periphery of the tubes to be fitted thereinto. The machine is pneumatically actuated and can drive one or two tubes at a time though the aligned apertures in the fins. Following insertion of the fin or fins, the machine can subsequently be used to insert one or two further tubes into respective apertures of the fins, until all of the tubes have been inserted thereinto.

Another machine for finning the tubes of a heat exchanger is disclosed in WO02/30591. That machine also utilises a cartridge into which the fins are loaded prior to being driven onto the tubes.

A machine for making fin block (though as with the machine of WO02/30591 it can also apply individual fins to individual tubes) is disclosed in WO96/35093. That machine utilises a linear motor to drive a fin (or common-fin) onto one or more tubes.

All of the above documents disclose pushing the tubes through the (stationary) fins, and/or pushing the fins onto (stationary) tubes. In all cases, it is necessary that the tubes do not buckle or deform during the finning operation, and this places a limit on the minimum wall thickness of the tubes and the degree of thermal contact between the tubes and the fins.

As above indicated, to facilitate greater heat exchange it is desired to reduce the thickness of the tube walls and also to increase the contact between the tubes and the fins. Satisfying the latter desire results in an increase in the frictional resistance between the tubes and the fins during relative movement, so that a greater force is required to apply the fins to the tubes. Satisfying the former desire results in a tube which is more likely to buckle or deform when the force needed to apply the fins to the tubes is imparted to it. Accordingly, when using the prior art machines it is necessary to compromise somewhat on heat exchange capability.

### SUMMARY OF THE INVENTION

The present invention seeks to reduce or avoid the problems associated with the prior art machines and methods described above, and in particular to provide a tube finning machine, and a method of finning the tubes of a heat exchanger, which avoids or reduces the above-stated problems and need to compromise on heat exchange capability.

According to the present invention therefore, there is provided a tube finning machine having a base, first mounting means for mounting at least one tube upon the base, second mounting means for mounting a number of fins upon the base, at least one of the first and second mounting means being movable relative to the base, characterised by tensioning means for applying a tensile force to at least part of the tube(s) whilst the fins are being applied thereto.

The present invention therefore applies a tensile force to all or part of the tube during the finning operation, whereas with the prior art machines the force upon the tubes is solely compressive. The tensile force will reduce or eliminate the compressive force acting along the longitudinal axis of the tube(s) and so reduce any tendency of the tube(s) to buckle or deform during the finning operation.

Preferably, the first mounting means is located adjacent one end of the tube(s), and the tensioning means is connected adjacent to the other end of the tube(s). Preferably also, the tensioning means includes a connector secured to the (or each) tube, the connector being connected to a drive means by which tension can be applied to the tube by way of the connector.

Desirably, the connector has a tapered leading end to facilitate passage of the connector, and subsequently the tube, through the fins.

Preferably, and in common with many prior art designs, the fins each have an aperture preformed therein for receiving the tube(s). Desirably, the aperture is surrounded by a collar which can facilitate thermal transfer between the tube and fin.

It will be understood that the present invention is directed to fins which are a force fit onto the tubes, so that the cross-sectional dimension of the aperture (or collar) is formed to be slightly smaller than the cross-sectional dimension of the tube. This will ensure that when the fin is fitted to the tube there is a good thermal engagement therebetween. The invention is expressly not related to machines in which the apertures in the fins are initially larger than the tubes, and in which the tubes are subsequently expanded (e.g. by a bulleting operating) into engagement with the fins. The use of a bulleting operation is highly disadvantageous, and places additional restrictions on the tubes and the fins.

Preferably, the second mounting means is substantially fixed relative to the base, so that the fins are maintained substantially stationary relative to the base during the finning operation, and the tube(s) are driven to move relative to the base and fins. In alternative embodiments the second mounting means (and therefore the fins) are movable relative to the base, and in yet further alternative embodiments both of the first and second mounting means (and hence both of the tubes and fins) are movable relative to the base.

In embodiments in which the first mounting means is movable, the tube(s) can be driven to move relative to the base and to the tubes solely by the tensioning means, i.e. the tubes are pulled through the fins. Alternatively, a drive means can be provided which acts upon the first mounting means, so that the tubes can be simultaneously pulled by the tensioning means and pushed by the drive means.

Desirably, the connector is secured to the tube by way of a lip formed at the end of the tube. Desirably also, the first mounting means includes a mandrel which is located within the tube and which engages the lip, the lip being located, and preferably secured, between the mandrel and the connector. Preferably, the connector and mandrel have cooperating threads by which they may be screw-fitted together. The mandrel may be a close fit within the tube, i.e. there may be only small difference between the cross-sectional dimension of the mandrel and the cross-sectional dimension of the tube (perhaps 0.1 mm or thereabouts). Such a small difference would allow the mandrel to be moved into and out of the tube without undue difficulty, but would enable the mandrel to support the tube against any tendency to buckle or deform (notwithstanding the expectation that such tendency is unlikely in practice).

Alternatively or additionally, a pushing force can be imparted to the tube by way of the mandrel.

Desirably, the tensioning means includes a drive means which causes the tensioning means to move so as to maintain tension in the tube during movement thereof.

It is expected that machines according to the present invention will be particularly suitable for applying fins to a large number of tubes simultaneously, i.e. a large number of tubes may be connected to a common drive means and the tubes pulled (and if desired also pushed) through the fins together. In particular applications, it is possible to drive all of the tubes of a heat exchanger through all of the fins of that heat exchanger in a single operation, so that the heat exchanger can be manufactured very quickly.

If is of course a desirable feature of the fins that they transfer heat quickly and effectively into the coolant which will flow around and between the fins in use. Generally, thinner fins will allow a greater rate of thermal transfer. Thinner fins are, however, more likely to bend or buckle during insertion of the tubes, and it is therefore desirable to provide support means to support the fins during the finning operation, thin fins typically requiring more that mere peripheral support. Also, the heat exchanger may require very closely-spaced fins and providing support for all (or at least a substantial part) of each fin is difficult.

The greater the number of tubes being inserted at one time the more likely that bending or buckling will occur, and also the greater the difficulty in ensuring adequate support across the whole of the fins, particularly adjacent those tubes most remote from the outside surface of the heat exchanger.

Accordingly, a solid material may be introduced between the fins, which solid material supports the fins during the finning process, but can be removed from the assembled heat exchanger after the finning process has been completed. The solid material can comprise discrete grains or the like, such as sand or ball bearings, or can comprise a continuous solid material such as ice.

The present invention therefore also provides a method of supporting the fins during the insertion of tubes, the method comprising the steps of {i} arranging a chosen number of fins at a chosen spacing, the fins having apertures for receiving tubes therethrough, {ii} introducing a solid material into the gaps between the fins, {iii} inserting the tubes through respective apertures, and {iv} removing the solid material. Preferably, the method is utilised with the machine as herein defined, but it will be understood that it could be used with other tube finning machines.

Preferably, the method includes the additional step of locating a drive member through the apertures in the fins, before step numbered {ii} above. The drive member can be a pull rod as described herein, or can be a dowel or the like which is removed after the introduction of the solid material to be replaced by a pull rod.

It will be understood that the dowel or pull rod will not occupy as great a volume as a tube, so that if the support material is a continuous solid some of that solid will have to be removed to allow the tubes to pass therethrough. This can be achieved by incorporating melting means ahead of the tube so that the required volume of solid material (e.g. ice) is melted and can be removed as the tubes pass through the fins.

If the solid material is granular such as sand or ball bearings, then the solid material can be forced out of the way by the leading end of the tube(s), it being arranged that the drive means can provide sufficient force to drive the tubes through the fins and also drive the excess solid material out of the way of the leading end of the tubes. It can be arranged that the fins and tubes are caused to vibrate during the finning process, it being understood that granular materials flow more easily when under vibration. Clearly, the vibration should be not so great to reduce the support offered by the solid material to the body of the fins.

The solid material will be removed from the assembled heat exchanger upon completion of the finning process. The solid material will desirably be chosen with the ultimate heat exchanger application in mind, i.e. it will not be desirable to use sand as the solid material in any heat exchanger for use with oil since any sand inadvertently not removed from the heat exchanger may cause subsequent damage to the heat exchanger or to the components to which it is connected. Ball bearings may also damage a heat exchanger or connected components if not removed, but are far less likely to be left in the heat exchanger because of their relatively large size.

Clearly, ice can readily be used as the solid material in any heat exchanger destined for a water-based application.

When using water or other freezable liquid as the solid material, the material is preferably added in its liquid state so that it completely fills the spaces between the fins and ensures complete support therefor. Since water expands upon freezing, care must be taken to ensure that the fins are not damaged or distorted during the freezing operation.

Other freezable liquids can be used instead of water, it being known for example that some metallic materials (such as “Cerabend”™) will be solid at normal room temperature (20° C.) and liquefy at temperatures below 100° C., so that these materials can provide support for the fins at room temperature and yet be introduced and removed at readily attainable temperatures which will not damage any of the heat exchanger componentry.

### BRIEF DESCRIPTION OF THE DRAWINGS

The invention will now be described, by way of example, with reference to the accompanying drawings, which show:

FIG. 1 is a perspective view of a tube finning machine according to the present invention;

FIG. 2 is a schematic representation, partly in section, of part of another embodiment of tube finning machine, prior to the operation of the machine; and

FIG. 3 is a side sectional view of an alternative means for connecting the tensioning means to the tube.

### DESCRIPTION OF THE PREFERRED EMBODIMENT

For ease of reference, in the following description similar components are given the same reference numeral, notwithstanding the description of different embodiments.

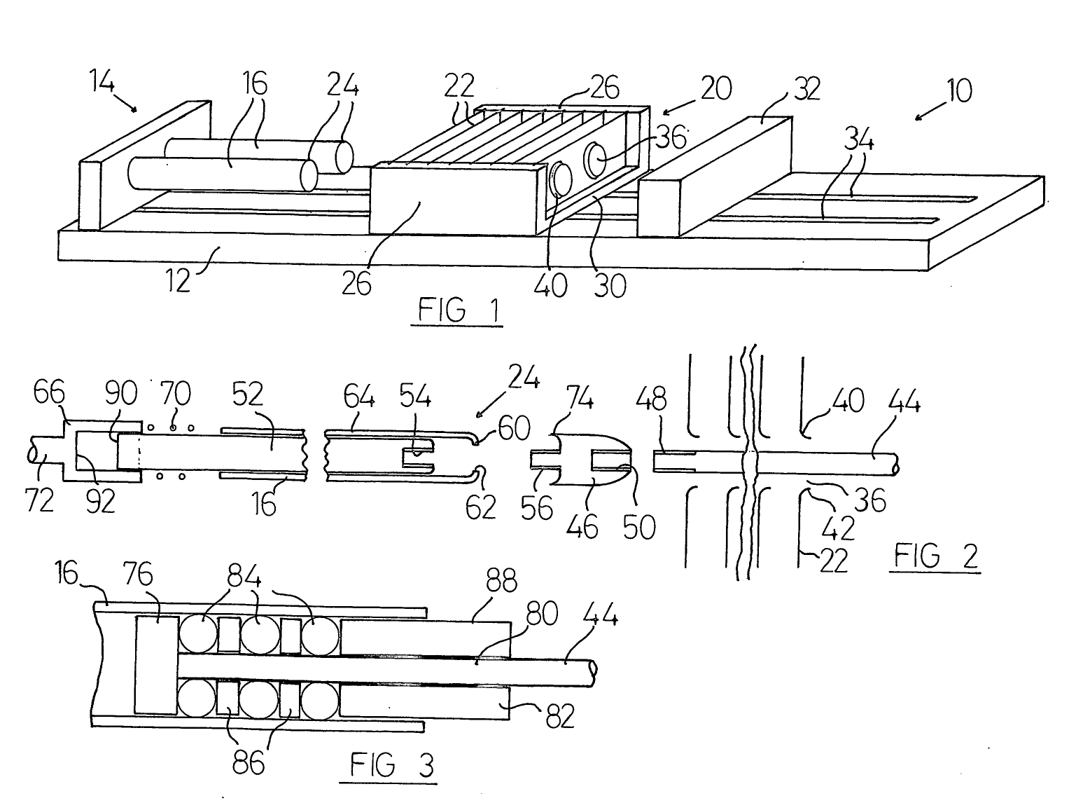

The machine 10 of FIG. 1 has a base 12, a first mounting means 14 by which two tubes 16 are mounted upon the base, and a second mounting means 20 by which a number of fins 22 are mounted upon the base 12.

As is typical in tube finning machines, the tubes 16 are mounted in cantilever by the first mounting means 14, so that each tube has a free end 24 to receive the fins 22. A part of one suitable first mounting means is described in relation to FIG. 2 below, but it will be understood that many different means of mounting the tubes 16 to the base 12 could be used.

As is also typical in tube finning machines, the second mounting means 20 comprises a cartridge which can accommodate the required number of fins. The cartridge 20 has a number of slots formed into its side walls 26 and base 30, each of which slots can accommodate a part of the periphery of a fin 22. In this way, the cartridge can set the relative spacing of the fins as required by the heat exchanger to be made, and can support those fins during insertion of the tube(s). It will be understood that the cartridge 20 is removable from the base 12 so that the loading of the fins 22 into the cartridge 20 (which is usually the slowest part of the manufacturing process) can be undertaken as a separate operation.

FIG. 1 also shows a part of the tensioning means of the present invention, specifically the driver 32 which as decribed below provides or transmits the driving force pulling the tubes 16 through the fins 22.

The base 12 has two channels 34 formed therein. The first mounting means 14 and the driver 32 have parts (not shown) which project into the channels 34, the projecting parts and channels serving to guide the first mounting means 14 and the driver 32 during movement relative to the base 12. If desired, the cartridge 20 can also have parts projecting into the channels, but that is not necessary in this embodiment since the carriage 20 is mounted to be stationary relative to the base 12.

Also, in this embodiment all of the driving force for the tubes is provided by the driver 32, so that the channels 34 act only as guides for the first mounting means 14. The driver 32 can contain all or part of the drive means such as an electric motor or linear motor for example. Alternatively the driver 32 can be connected to a separate drive means (not shown), for example by cable, chain or other suitable means, ideally located in one or both of the channels 34.

As above stated, in this embodiment the fins 22 are maintained stationary relative to the base 12 during the finning operation and so the first mounting means 14 (and the tubes 16) is movable relative to the base 12 and to the fins 22. In other embodiments the second mounting means (and hence the fins) are movable relative to the base and the first mounting means is fixed relative to the base, and in yet other embodiments both of the first and second mounting means are movable relative to the base.

In common with some of the prior art machines, the drive means, i.e. the source of power for the driver 32, can be a drawbench (utilising a chain drive for example), a linear motor, another electrically powered drive means, or a pneumatic or hydraulic drive means.

Also in common with some of the prior art arrangements, each fin 22 has an aperture 36 through which the tube can be passed, the aperture being surrounded by an annular collar 40. The function of the collar 40 is to increase the thermal transfer between the tube 16 and the fin 22 in the assembled heat exchanger, and the presence of a collar is typical with metallic fins. To ensure a good thermal contact between the tube 16 and the fins 22 the edge 42 (see FIG. 2) of each collar 40 is slightly smaller than the outer wall of the tube 16, so that the fins are a force fit upon the tube 16. The heat exchanger designer therefore can take advantage of the resilience of the collar 40 to ensure that when the fin 22 has been applied in its chosen position upon the tube 16 the collar will grip the tube and ensure a good thermal contact therebetween. It will therefore be understood that the drive means must provide sufficient force to stretch the collar 40 (and in particular the edge 42 thereof) as the fins 22 engage the tube 16.

Although not shown in FIG. 1, according to the present invention the driver 32 is connected to the free end 24 of each tube 16. In the embodiment of FIG. 2 the driver is connected to a pull rod 44 which can be passed through the apertures 36 in the fins 22 to engage a connector 46. The pull rod 44 is connected to the connector 46 by way of its threaded end 48 being inserted into the correspondingly threaded well 50 formed in the connector 46.

The connector 46 is in turn connected to the free end or leading end 24 of the tube 16 by way of a mandrel 52 which can be fitted into the tube 16, the mandrel 52 having a threaded well 54 to receive the correspondingly threaded boss 56 of the connector 46.

The leading end 24 of the tube 16 has an inwardly-deformed lip 60 formed thereon, which lip may be produced during manufacture of the tube, or as a preliminary process step before installation of the tube 16 on the tube finning machine 10.

The opening 62 surrounded by the lip 60 is smaller than the mandrel 52 so that the mandrel cannot pass therethrough. The opening 62 is, however, larger than the boss 56, so that the boss 56 can be passed therethrough to engage the mandrel. Accordingly, when the mandrel 52 has been moved slightly to the right from the position as drawn in FIG. 2 into engagement with the lip 60, and the connector 46 has been secured to the mandrel 52, the mandrel and therefore also the tube 16 can be pulled by its leading end 24 by way of the connector 46.

It will be understood that the form of the lip 60 is not important provided that it can serve to secure the connector 46 to the leading end 24 of the tube 16. Thus, the formation of the lip into a flange perpendicular to the axis of the tube as with the lip 60 is not necessary, and the lip can instead taper inwardly. It is also not necessary that the whole of the periphery of the tube wall be deformed into the lip, but instead the lip can comprise separate inwardly deformed sections of the tube wall, if desired.

It can be arranged that the drive means for moving the tube(s) is only connected to the leading end of the tube 16 (as in the embodiment of FIG. 1), so that the only force acting upon the tube 16 is a tension force applied to its leading end, and it is solely pulled through the apertures 36 in the fins 22. Alternatively, as in the embodiment of FIG. 2, the first mounting means 14 is also driven, so that the tube 16 is both pulled and pushed through the apertures 36 in the fins 22.

In such embodiments, since at least part of the force acting upon the tube 16 is a tensile force, the tendency of the tube to buckle or deform during fitment of the fins is reduced over the prior art arrangements in which all of the force upon the tube acts in compression. The wall 64 of the tube 16 can therefore be made of thinner (and perhaps softer) material than is possible with the prior art machines, without need to reduce the thermal engagement (and thus the frictional resistance to relative movement) between the tube and the fins. The heat transfer capability of the assembled finned tube can therefore be increased.

In the embodiment shown in FIG. 2, the first mounting means includes a housing 66 for each of the tubes 16, the end of the mandrel 52 being located within the housing 66. Between the housing 66 and the trailing end of the tube 16 is located a compression spring 70. The housing 66 is connected to a push rod 72 which in turn is connected to a further drive means (not shown), or if desired to the same drive means as for the pull rod 44. When driven to move by its drive means, the housing 66 can impart a compressive (or pushing) force to the tube 16 by way of the spring 70.

By varying the length of the mandrel 52 relative to the tube 16 and so adjusting the position of the trailing end of the tube 16 in relation to the housing 66, and by adjusting the rating of the spring 70, the machine user can vary the compressive force acting upon the tube 16. It will be appreciated that a weaker spring, with less initial compression, will impart only a small compressive force to the tube 12, so that almost all of the force applied to move the tube will be tensile. On the other hand, a strong spring, with a greater amount of initial compression, will impart a large compressive force to the tube 12, so that a large proportion of the force applied to the tube is compressive.

To operate the machine according to the embodiment of FIG. 2, the tube 16 is fitted over the mandrel 52, and is secured thereto by way of the connector 46 being screwed into the well 54 of the mandrel. The fins 22 are installed on the machine, usually in a cartridge such as 20 as above described, with the apertures 36 aligned with the longitudinal axis of the tube 16. The pull rod 44 is then passed through the apertures 36 and connected to the connector 46. If desired the connector 46 can be connected to the mandrel 52 and the pull rod 44 at the same time, for example by the use of opposite threads on the boss 56 and in the well 50 of the connector, or else it can be arranged that the threads are similar and either the mandrel 52 or the pull rod 44 can rotate freely to allow their interconnection.

The drive means is then actuated to cause the pull rod 44 and connector 46 to pull the tube 16 through the apertures 36 in the fins 22. At the same time, the drive means (or the secondary drive means if applicable) drives the first mounting means 14 so as also to push the tube 16 through the apertures 36 in the fins 22.

It will be seen that the connector 46 has a tapered leading end, the purpose of which is to cause the collars 40 of the fins 22 to stretch as the connector 46 is forced therethrough. The provision of a taper is preferred over a flat leading end since it allows the gradual expansion of the collar to the size required to pass the tube and consequently a gradual increase in the force required, rather than a sudden increase in the force required as would be the case if the collar was required to pass a step. In addition, the trailing end of the connector is shaped at 74 to closely match the leading end of the tube 16, to avoid a recess into which the collar 40 could engage. Also, because of its tapered shape the connector 46 acts to centralise the pull rod 44 and tube 16 relative to the apertures 36.

In the drawing, the cross-sectional dimension of the mandrel 52 is shown as being slightly smaller than the cross-sectional dimension of the tube, so that the mandrel will be a relatively loose fit inside the tube 16. However, since the presence of a mandrel is required in this embodiment, it would be possible to exploit the mandrel by making it only slightly smaller than the tube, these parts perhaps differing in cross-sectional dimension by around 0.1 mm or so. Whilst this would likely make it more difficult to insert the mandrel into the tube the mandrel could act to resist any tendency of the tube to deform or buckle during the finning operation. Such a machine could be used with tubes having a very thin wall, which wall could be very effective in transferring heat to the fins.

The wall of the tube must of course be thick enough to withstand the pressure exerted by the collars of the fins, but since the tube will typically be circular and the force exerted by the collar will be equal around the tube wall, a thin tube wall could withstand a relatively large collar pressure. Thus, it is recognised that the greatest tendency of the tube to buckle or deform is during the finning process as the tube is forced through the fin apertures. Provided that the mandrel supports the tube during that process it will not be required to support the tube wall once the finning process is completed.

Whilst FIG. 2 shows only one tube and a number of fins (and FIG. 1 shows two tubes and eight fins), the invention could equally well be used to make a fin block in which a chosen number of tubes are driven through the apertures in a chosen number of fins. The machine could have a number of pull rods each acting together so that some or all of the tubes of the fin block are finned together, or it could have just a single pull rod so that one tube is inserted into the fins at a time. In machines having a number of pull rods it could be arranged that their connection to the respective tubes is slightly offset so that they move their respective tubes in sequence rather than simultaneously; such embodiments would prevent the drive means from having to provide sufficient force to stretch several fin collars at the same time.

It will be understood that the invention could equally well be utilised in a machine in which the fins are moved relative to tubes which are fixed relative to the base. In such embodiments, the “pull rod” 44 could be secured to a substantally stationary “driver” 32), and the second mounting means (e.g. cartridge 20) be driven to move (towards the left as drawn in FIG. 1). As the fins are forced over the tube(s) the pull rod 44 would act to hold the tubes 16 stationary and so maintain a tensile force in all or part of the tube(s).

FIG. 3 shows another method of securing the pull rod 44 to the leading end 24 of the tube 16. In this embodiment, the leading end 24 of the tube requires no deformation or machining. The pull rod 44 is securely connected to an end piece 76, and has a threaded part 80 which accommodates a correspondingly threaded nut 82. Between the end piece 76 and the nut 82 are located three resilient O-rings 84 and two spacers 86. The O-rings 84 and the spacers 86 can move substantially freely relative to the pull rod 44. The end piece 76, the O-rings 84 and the spacers 86 are sized to fit within the tube 16. The nut 82 can also fit within the tube, but as shown in FIG. 3 is intended to be fitted only partially thereinto, so that a part 88 thereof projects from the tube 16.

To secure the pull rod 44 to the tube 16, the end piece 76, the O-rings 84, spacers 86 and part of the nut 82 are inserted into the tube. It is arranged that the part 88 of the nut 82 is a circular (e.g. formed as a hexagon) or has a recess or recesses to accommodate a tool, by which it may be rotated relative to the pull rod 44. By rotating the nut 82 relative to the pull rod 44, the cooperating threads cause it to move towards the end piece 76, compressing the O-rings 84. As the O-rings 84 are compressed longitudinally they are caused to expand radially into engagement with the inside of the tube 16. By a suitable choice of the material from which the O-rings are made, and choosing suitable dimensions for the various components, it can be arranged that a considerable frictional engagement can be created between the O-rings and the tube, and hence between the pull rod 44 and the tube 16, the frictional engagement allowing the required tension force to be applied to the tube 16 by way of the pull rod 44.

Clearly, more or fewer than three O-rings 84 can be used as desired, with or without intermediate spacers 86. Also, whilst a connector is not shown in FIG. 3, it will be appreciated that a suitable tapered component to slowly stretch the apertures in the fins, could be fitted over the part 88 of the nut 82 if desired.

In another embodiment of machine according to the invention, and with reference to FIG. 2, the mandrel 52 could be driven to move by way of the housing 66, specifically by the end 90 of the mandrel engaging the wall 92 of the housing. It will be understood that a force imparted to the end 90 of the mandrel 52 will be communicated (by the mandrel) to the leading end 24 of the tube, with the mandrel being forced against the lip 60. In this way, the housing 66 could be used to apply the required tensile force to the tube 16, the mandrel pushing the leading end 24 of the tube through the fins. Whilst the force upon the mandrel 52 would be compressive the force upon the tube would be tensile, so satisfying the requirement of the present invention. A connector 46 would not be required to secure the mandrel to the tube 16 (though a similar connector would be preferred to control the stretching of the fin collars) and a pull rod such as 44 would not be required.

Such embodiments could still if desired utilise a compression spring 70 so as to provide some compressive force along the tube, but it would be required that the rating of the spring 70 be small enough to allow the mandrel to engage the wall 92. Alternatively, a second compression spring could be provided within the housing 66 between the end 90 of the mandrel and the wall 92, the relative ratings of the springs determining the ratio of tension/compression in the tube during the finning operation.

Clearly, in those embodiments having a pull rod, that component could be a flexible cable or the like, but it is desirable that the pull rod have some rigidity so as to facilitate its passage through the apertures in the fins. Also in such embodiments, it is not necessary that the mandrel extend the full length of the tube, and the mandrel could be replaced by a nut or the like inserted into the leading end 24 of the tube 16.

1. A tube finning machine having a base, first mounting means for mounting at least one tube upon the base, second mounting means for mounting a number of fins upon the base, at least one of the first and second mounting means being movable relative to the base, characterized by tensioning means for applying a tensile force to at least part of the tube(s) while the fins are being applied thereto.

2. A tube finning machine according to claim 1 in which the first mounting means is located adjacent one end of the tube(s), and the tensioning means is connected to the other end of the tube(s).

3. A tube finning machine according to claim 1 in which the tensioning means includes a connector secured to the or each tube, the connector being connected to a drive means, tension being applied to the tube by way of the connector.

4. A tube finning machine according to claim 3 in which the connector has a tapered leading end to facilitate passage of the connector, and subsequently the tube, through the fins.

5. A tube finning machine according to claim 1 in which the second mounting means is substantially fixed relative to the base, so that the fins are maintained substantially stationary relative to the base during the finning operation, and in which the tube(s) are driven to move relative to the base and fins.

6. A tube finning machine according to claim 5 in which the tube(s) can be driven to move relative to the base and to the tubes solely by the tensioning means.

7. A tube finning machine according to claim 1 in which the tensioning means is connected to the tube by way of a lip formed at the end of the tube.

8. A tube finning machine according to claim 1 in which the first mounting means includes a mandrel which is located within the tube.

9. A tube finning machine according to claim 8 in which the mandrel engages the lip.

10. A tube finning machine according to claim 1 having further drive means for imparting a compressive force to the tube.

11. A method of finning a tube comprising the steps of {i} providing a tube finning machine having a base, first mounting means for mounting at least one tube upon the base, second mounting means for mounting a number of fins upon the base, at least one of the first and second mounting means being movable relative to the base, and tensioning means for applying a tensile force to at least part of the tube(s) whilst the fins are being applied thereto, {ii} mounting at least one tube upon the base by way of the first mounting means, {iii} mounting a number of fins upon the base by way of the second mounting means, {iv} actuating the tensioning means to move the tubes relative to the fins.

12. A method according to claim 11 in which a solid material is introduced into the gaps between the fins so as to support the fins during the finning process.
